(19) United States
(12) Patent Application Publication
(10) Pub. No.: US 2005/0021325 A1
(43) Pub. Date: Jan. 27, 2005

(54) Apparatus and method for detecting a pitch for a voice signal in a voice codec

(76) Inventors: Jeong-Wook Seo, Buk-gu (KR); Hwan Kim, Gumi-si (KR); Yang-Hyun Lee, Gumi-si (KR); Keun-Sung Bae, Suseong-gu (KR); Si-Ho Kim, Dalseo-gu (KR); Seung-Won Lee, Suseong-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/883,968

(22) Filed: Jul. 6, 2004

(30) Foreign Application Priority Data
Jul. 5, 2003 (KR) 2003-45550

(51) Int. Cl. G10L 11/04

(52) U.S. Cl. 704/207

(57) ABSTRACT

An apparatus and method for detecting a pitch of a voice signal in a codec. The pitch detection apparatus for use in a vocoder includes a bandwidth expansion unit for performing an inverse-filtering process and a bandwidth expansion process on an input voice signal, and generating a bandwidth-expanded residual signal; a pitch analyzer for calculating a time autocorrelation function and a spectral autocorrelation function of the bandwidth-expanded residual signal, mixing the time autocorrelation function and the spectral autocorrelation function, comparing an autocorrelation function calculated by dividing a pitch acquired from the mixed autocorrelation function by an integer multiple with another autocorrelation function acquired at a predetermined pitch, and determining a point or position having the highest value to be an open-loop pitch; a pitch smoothing unit for smoothing the open-loop pitch using an average pitch value when the detected open-loop pitch is outside of a predetermined range of a previous frame; and a pitch quantizer for quantizing the smoothened open-loop pitch into predetermined levels, and generating the quantized result.

### PRIORITY

This application claims the benefit under 35 U.S.C. § 119(a) of an application entitled “APPARATUS AND METHOD FOR DETECTING PITCH OF VOICE SIGNAL IN VOICE CODEC”, filed in the Korean Intellectual Property Office on Jul. 5, 2003 and assigned Serial No. 2003-45550, the entire contents of which are incorporated herein by reference.

### BACKGROUND OF THE INVENTION

1. Field of the Invention

The present invention relates to a voice codec device and a method for controlling the same. More particularly, the present invention relates to an apparatus and method for analyzing pitches from among a variety of parameters for use in a voice codec device, resulting in quantization of the pitches.

2. Description of the Related Art

Typically, a voice coding method is classified into one of the following three voice coding methods: a first voice coding method that quantizes a voice signal waveform, and encodes the quantized voice signal waveform; a second voice coding method that is indicative of a parameter coding method called a vocoding method which encodes a variety of parameters acquired by modeling a voice signal using a digital system, for example, linear prediction coefficients, pitches, gains, and voiced and unvoiced sound, and so on; and a third method that is indicative of a hybrid coding method for properly mixing individual advantages of the aforementioned first and second methods.

The aforementioned waveform coding method has a relatively-high transfer rate of more than 32 kbps whereas it achieves excellent sound quality similar to the original sound. Representative waveform coding methods are a Pulse Coded Modulation (PCM) method, and a modified PCM such as an Adaptive Differential PCM (ADPCM), and so on. The vocoding method has unnatural sound quality whereas it can reduce a transfer rate to less than a predetermined transfer rate of 3 kbps. Representative voice coders for use in the above vocoding method are an LPC-102 vocoder indicative of the US Department of Defense standard, and a Mixed Excitation Linear Prediction (MELP) vocoder indicative of an improved LPC-102 vocoder. The hybrid coding method can achieve excellent sound quality at a transfer rate of 4.8 kbps-16 kbps using the advantages of the aforementioned two methods. A representative method uses a Code Excited Linear Prediction (CELP)—based voice coder, which has been modified and developed in various ways throughout the world, such that it is currently adapted as a communication service standard.

However, voice codec devices using the aforementioned methods greatly deteriorate the sound quality because they include an insufficient number of bit allocations for expressing a codebook at a low transfer rate of less than 4 kbps, resulting in a limitation in implementing a low-speed voice coder. For example, it is preferable that mobile communication terminals (e.g., cellular and Personal Communications Service (PCS) phones, and Personal Digital Assistants (PDAs), and so on) having limitations in CPU performance and memory size are adapted as a medium-low speed voice coder. In order to implement the aforementioned medium-low speed voice coder, characteristic parameters must be extracted from a voice signal and an effective bit allocation method that considers the number of calculations must first be performed to guarantee excellent sound quality of the reproduction. The principal parameters indicative of voice signal characteristics for use in the aforementioned voice coding methods may be determined to be bandpass voiced sound intensity, linear prediction coefficients (LPCs), gains, and LPC residual signals, and so on.

### SUMMARY OF THE INVENTION

Therefore, the present invention has been made in view of the above problems, and it is an object of the present invention to provide an apparatus and method for detecting a pitch of a voice signal for use in a voice codec device.

It is another object of the present invention to provide an apparatus and method for expanding a bandwidth of a voice signal received from a voice codec device, and detecting pitch information from the bandwidth-expanded voice signal.

It is yet another object of the present invention to provide an apparatus and method for calculating individual autocorrelation functions from time and frequency domains of a voice signal received from a voice codec device, and detecting pitch information using the calculated autocorrelation functions.

It is yet another object of the present invention to provide an apparatus and method for detecting pitch information capable of minimizing an error between a synthetic sound spectrum and an original sound spectrum on the basis of a specific pitch detected from a voice codec device.

It is yet another object of the present invention to provide an apparatus and method for expanding a bandwidth of an entry voice signal, calculating individual autocorrelation functions of time and frequency domains of the bandwidth-expanded voice signal, detecting pitch information using the calculated autocorrelation functions, and detecting specific pitch information capable of minimizing an error between a synthetic sound spectrum and an original sound spectrum on the basis of the detected pitch information.

In accordance with one aspect of the present invention, the above and other objects can be accomplished by the provision of a pitch detection apparatus for use in a vocoder. The apparatus comprises a bandwidth expansion unit for performing an inverse-filtering process and a bandwidth expansion process on an input voice signal, and generating a bandwidth-expanded residual signal; a pitch analyzer for calculating a time autocorrelation function and a spectral autocorrelation function of the bandwidth-expanded residual signal, mixing the time autocorrelation function and the spectral autocorrelation function, comparing an autocorrelation function calculated by dividing a pitch acquired from the mixed autocorrelation function by an integer multiple with another autocorrelation function acquired at a predetermined pitch, and determining a point or position having the highest value to be an open-loop pitch; a pitch smoothing unit for smoothing the open-loop pitch using an average pitch value when the detected open-loop pitch is outside of a predetermined range of a previous frame; and a pitch quantizer for quantizing the smoothened open-loop pitch into predetermined levels, and generating the quantized result.

In accordance with another aspect of the present invention, there is provided a pitch detection apparatus for use in a vocoder. The apparatus comprises a bandwidth expansion unit for performing an inverse-filtering process and a bandwidth expansion process on an input voice signal, and generating a bandwidth-expanded residual signal; a Low Pass Filter (LPF) for low-pass-filtering the input voice signal using a predetermined frequency band; a pitch analyzer for calculating a time autocorrelation function and a spectral autocorrelation function of the bandwidth-expanded residual signal, mixing the time autocorrelation function and the spectral autocorrelation function, performing a double-pitch search process on the pitch calculated by the mixed autocorrelation function, determining a point having the highest value to be an open-loop pitch, calculating a time autocorrelation function of the low-pass-filtered voice signal when an autocorrelation function acquired from the detected open-loop pitch is less than a predetermined reference value, and performing the double-pitch search process to search for an open-loop pitch; a pitch smoothing unit for smoothing the open-loop pitch using an average pitch value when the detected open-loop pitch is outside of a predetermined range of a previous frame; and a pitch quantizer for quantizing the smoothened open-loop pitch into predetermined levels, and generating the quantized result.

In accordance with yet another aspect of the present invention, there is provided a method for detecting a pitch from among an input voice signal in a vocoder. The method comprises performing an inverse-filtering process and a bandwidth expansion process on an input voice signal, and generating a bandwidth-expanded residual signal; calculating a time autocorrelation function and a spectral autocorrelation function of the bandwidth-expanded residual signal, mixing the time autocorrelation function and the spectral autocorrelation function, comparing an autocorrelation function calculated by dividing a pitch acquired from the mixed autocorrelation function by an integer multiple with another autocorrelation function acquired at a predetermined pitch, and determining a point or position having the highest value to be an open-loop pitch; smoothing the open-loop pitch using an average pitch value when the detected open-loop pitch is outside of a predetermined range of a previous frame; and quantizing the smoothened open-loop pitch into predetermined levels, and generating the quantized result.

In accordance with yet another aspect of the present invention, there is provided a method for detecting a pitch of a voice signal in a vocoder. The method comprises performing an inverse-filtering process and a bandwidth expansion process on an input voice signal, and generating a bandwidth-expanded residual signal; low-pass-filtering the input voice signal using a predetermined frequency band; calculating a time autocorrelation function and a spectral autocorrelation function of the bandwidth-expanded residual signal, mixing the time autocorrelation function and the spectral autocorrelation function, performing a double-pitch search process on the pitch calculated by the mixed autocorrelation function, determining a point having the highest value to be an open-loop pitch, calculating a time autocorrelation function of the low-pass-filtered voice signal when an autocorrelation function acquired from the detected open-loop pitch is less than a predetermined reference value, and performing the double-pitch search process to search for an open-loop pitch; smoothing the open-loop pitch using an average pitch value when the detected open-loop pitch is outside of a predetermined range of a previous frame; and quantizing the smoothened open-loop pitch into predetermined levels, and generating the quantized result.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a voice codec device;

FIG. 2 is a block diagram illustrating a Pitch Analysis and Quantization (PAQ) unit in accordance with an embodiment of the present invention;

FIGS. 3A and 3B are graphs illustrating operational characteristics of a bandwidth expansion unit of FIG. 2 in accordance with an embodiment of the present invention;

FIG. 4 is a flow chart illustrating an operational procedure of a pitch analyzer of FIG. 2 in accordance with an embodiment of the present invention;

FIGS. 5A-5F are graphs illustrating operational characteristics of a pitch analyzer of FIG. 4 in accordance with an embodiment of the present invention;

FIG. 6 is a flow chart illustrating a procedure for determining a specific value ‘β’ in FIG. 4 in accordance with an embodiment of the present invention;

FIG. 7 is a flow chart illustrating a procedure for searching for a double pitch in FIG. 4 in accordance with an embodiment of the present invention; and

FIG. 8 is a flow chart illustrating a procedure for operating a pitch smoothing unit in accordance with another embodiment of the present invention.

Throughout the drawings, it should be noted that the same or similar elements are denoted by like reference numerals.

### DETAILED DESCRIPTION OF THE PREFERRED EMBODIMENTS

Embodiments of the present invention will now be described in detail with reference to the accompanying drawings. In the following description, a detailed description of known functions and configurations incorporated herein will be omitted for conciseness.

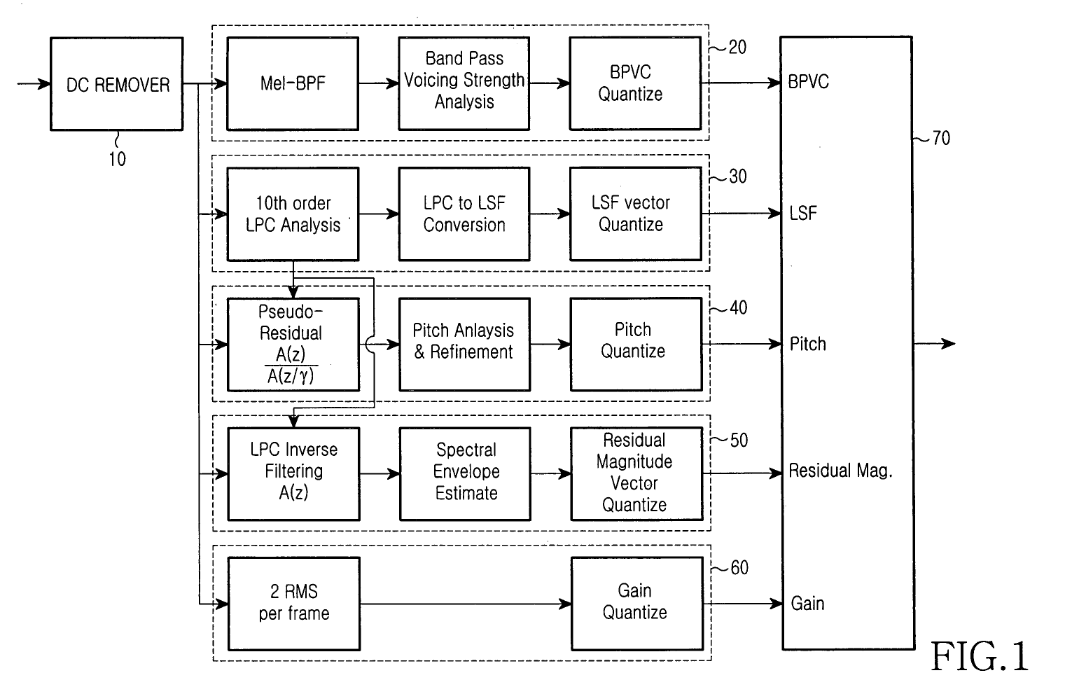

A variety of voice coding methods (also called vocoding methods), for example, a Code Excited Linear Prediction (CELP) coding method, a Harmonic Stochastic eXcitation (HSX) coding method, and a Mixed Excitation Linear Prediction (MELP) coding method, and so on have been widely used. A medium-low speed vocoding algorithm for use in a voice codec can be implemented using both a mixed excitation signal based on the MELP method for mixing voiced sound with unvoiced sound and a voice synthesis model adapting a linear prediction synthetic filter. Principal parameters indicative of voice signal characteristics needed when the voice synthesis model are equal to bandpass voiced sound intensity, linear prediction coefficients (LPCs), pitches, gains, and LPC residual signals. An apparatus for analyzing and quantizing a voice signal of an MELP vocoder on the basis of the aforementioned five principal characteristics is shown in FIG. 1.

Referring to FIG. 1, the Direct Current (DC) remover 10 high-pass-filters an input signal, such that a DC component is removed from a signal to be encoded.

The voice signal determination unit 20 for every bandwidth band-pass-filters the signal having no DC component using at least two bandwidths, and generates a parameter signal ‘BPVC’ for analyzing voiced sound intensities for every bandwidth.

The Linear Predict Analysis and Quantization (LPAQ) unit 30 calculates an autocorrelation function of a voice signal acquired by adapting a window to each frame, and extracts a Linear Predict Coefficient (LPC) using the Levinson algorithm. The extracted LPC is converted into a Line Spectral Frequency (LSF) having excellent quantization and interpolation characteristics, resulting in quantization of the LSF. The quantized LSF is converted into an LPC to calculate an impulse response characteristic of a synthetic filter.

The Pitch Analysis and Quantization (PAQ) unit 40 expands a bandwidth of an input signal, and checks an open-loop pitch of the bandwidth-expanded signal using autocorrelation functions calculated from time and frequency domains. The PAQ unit 40 performs a fine pitch search operation for searching for a specific pitch capable of minimizing an error between a synthetic sound spectrum and an original sound spectrum on the basis of the calculated open-loop pitch, and quantizes the searched pitch.

The LPC—Residual Signal Analysis and Quantization (RSAQ) unit 50 controls a magnitude spectrum of the LPC residual signal to search for a plurality of harmonic components (e.g., 20 harmonic components) when configuring an excitation signal, and then quantizes the searched harmonic components, such that the excitation signal is very similar to the original signal. The LPC-RSAQ unit 50 calculates a quantized LPC using the quantized LSF vector, generates an LPC residual signal using the quantized LPC, adapts a window used for LPC analysis to the generated LPC residual signal, performs a zero-padding operation on the resultant signal, and finally performs a Fourier Transform (e.g., 512-point Fast Fourier Transform) on the zero-padding result signal. Thereafter, the LPC-RSAQ unit 50 searches for harmonic components from the FFT magnitude using a spectral peak-picking algorithm. After searching for the harmonic components, the LPC-RSAQ unit 50 normalizes the searched harmonic components using a Root-Mean-Square (RMS) value, and quantizes the same using a codebook having a plurality of code vectors (e.g., 256 codes).

The Gain Analysis and Quantization (GAQ) unit 60 calculates a gain of the input signal, and quantizes the calculated gain.

A voice codec of FIG. 1 high-pass-filters an input voice signal to remove a DC component from the voice signal. The voice codec generates parameters for the coding operation using the voice signal having no DC component. In this case, the parameters are determined to be voiced sound intensities for every bandwidth (denoted by BPVC), a frequency of the LPC (denoted by an LSF), a pitch (denoted by Pitch), and an LPC residual signal (denoted by a Residual Mag.). The aforementioned parameters are quantized, and the quantized parameters are applied to the multiplexer 70, such that the multiplexeer 70 multiplexes the quantized parameters. The multiplexed parameters are encoded by an encoder (not shown).

The PAQ unit 40 of FIG. 1 can detect a pitch of an input voice signal using the following steps. Specifically, the PAQ unit 40 expands a bandwidth of an output voice signal of the DC remover 10, calculates autocorrelation functions of time and frequency domains of the bandwidth-expanded voice signal, and searches for an open-loop pitch using the calculated autocorrelation functions. Thereafter, the PAQ unit 40 performs a fine pitch search operation for searching for a specific pitch capable of minimizing an error between a synthetic sound spectrum and an original sound spectrum on the basis of the calculated open-loop pitch, quantizes the detected pitch, and applies the quantized pitch to the multiplexer 70.

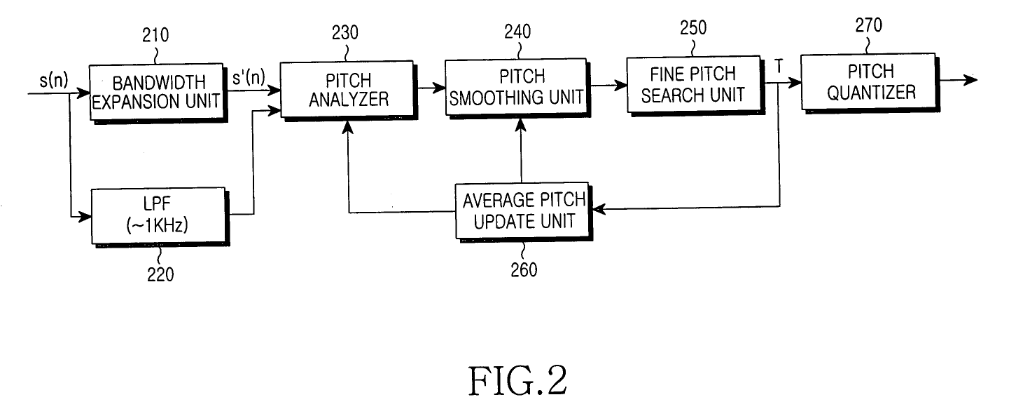

FIG. 2 is a block diagram illustrating the PAQ unit 40 in accordance with a preferred embodiment of the present invention.

Referring to FIG. 2, the bandwidth expansion unit (also called an inverse filtering & bandwidth expansion part) 210 expands a bandwidth of an input voice signal to compensate for distortion of the input voice signal. The pitch analyzer 230 receives the bandwidth-expansion residual signal from the bandwidth expansion unit 210, receives a low-pass-filtered signal of 1 kHz from the LPF 220, and analyzes an open-loop pitch using the above two reception signals. The pitch smoothing unit 240 performs a pitch smoothing operation to prevent an abrupt pitch variation from being generated from the open-loop pitch detection signal generated from the pitch analyzer 230. The fine pitch search unit 250 performs a fine pitch search operation to correct an unexpected error generated from the above open-loop pitch detection procedure. The average pitch update unit 260 updates average pitches to be used for the pitch analyzer 230 and the fine pitch search unit 250 upon receiving the last detection pitch from the fine pitch search unit 250. The pitch signal generated from the fine pitch search unit 250 is quantized by the pitch quantizer 270, and the quantized pitch signal is transmitted to the multiplexer 70.

Operations of the aforementioned PAQ unit 40 will hereinafter be described in detail.

First, operations of the bandwidth expansion unit 210 will hereinafter be described.

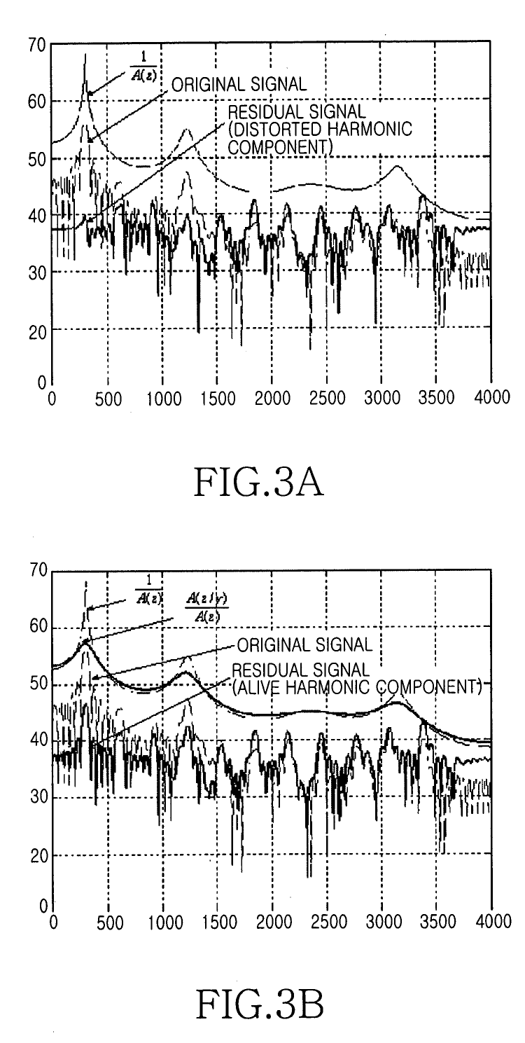

Signals for use in the pitch analyzer 230 are indicative of a bandwidth-expansion residual signal and a 1 kHz low-pass-filtered signal of the input signal. Typically, an input signal of an autocorrelation function for use in the open-loop pitch detection process is typically determined to be a residual signal. In this case, if a formant frequency exists in a pitch harmonic component during an inverse filtering time for calculating the residual signal, distortion arises for a corresponding harmonic component as shown in FIG. 3A. However, provided that a bandwidth expansion operation of the input voice signal is performed during the inverse filtering time of the input voice signal, the distortion of the harmonic component generable during the inverse filtering time can be corrected.

An equation for calculating the bandwidth-expansion residual signal is denoted by the following Equation 1:

$${S}^{′} ( z ) = \frac{A ( z )}{A ( z / γ )} \cdot S ( z ) \qquad Equation 1$$

With reference to Equation 1, γ is indicative of a weight factor. The closer the value of γ is to a specific value ‘1’, the closer the filtered signal is to an original signal. The closer the filtered signal is to a specific value ‘0’, the closer the filtered signal is to the residual signal. Therefore, it can be recognized that the signal processed by Equation 1 uses an intermediate signal between the original signal and the residual signal. In this case, γ is determined to be 0.8.

The bandwidth expansion unit 210 performs a bandwidth expansion when the input signal is inverse-filtered as shown in Equation 1. The inverse filtering process performed by the bandwidth expansion unit 210 is indicative of a process for making a residual signal using the original signal. The inverse-filtering operation is indicative of a process for smoothing an original signal spectrum, and divides an original signal by 1/A(z) or multiplies the original signal by A(z) as shown in FIG. 3A, such that a residual signal can be acquired. As shown in FIG. 3A, filter characteristics configured in the form of a sharpened shape occur in the inverse-filtering process as shown in FIG. 3A. If a first harmonic frequency overlaps with the formant frequency, distortion of a first harmonic component of the residual signal occurs. In this case, the distortion of the first harmonic component indicates that a periodic component corresponding to a pitch disappears from the viewpoint of a time axis. In the case of calculating a correlation coefficient using the residual signal having a distorted harmonic component as shown in FIG. 3A, a low correlation coefficient value is found in the vicinity of the pitch. In order to prevent the aforementioned disadvantages, the bandwidth expansion unit 210 in accordance with an embodiment of the present invention adds the value of A(z/γ) to the original signal when performing the inverse-filtering process, such that it can remove the sharpened portion from the original signal as shown in FIG. 3B, resulting in the maintenance of the residual signal's harmonic component.

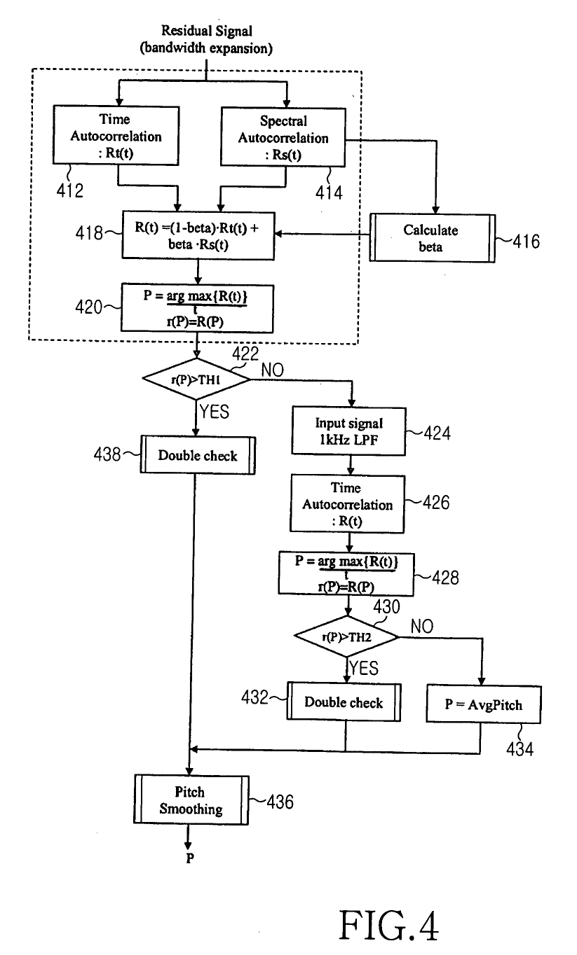

Secondly, operations of the pitch analyzer 230 will hereinafter be described. A method for performing an open-loop pitch analysis operation in the pitch analyzer 230 is shown in FIG. 4.

FIG. 4 shows two methods for calculating the open-loop pitch. Specifically, a first method is adapted to detect the open-loop pitch using a bandwidth-expanded residual signal at a pitch detection time, and a second method is adapted to detect the open-loop pitch using the bandwidth-expanded residual signal and low-pass-filtered signal less than a predetermined frequency.

The aforementioned first method does not perform steps 422-434 shown in FIG. 4. Specifically, the first method acquires time and spectral autocorrelation functions from the bandwidth-expanded residual signal, and mixes the time autocorrelation function with the spectral autocorrelation function to search for a double pitch, such that it detects an open-loop pitch.

The method for detecting the open-loop pitch using the pitch analyzer includes receiving the bandwidth-expanded residual signal, and calculating a time autocorrelation function and a spectral autocorrelation function; comparing a peak-to-valley difference value of the calculated spectral autocorrelation function with a predetermined value to determine a correction value; mixing the time autocorrelation function with the spectral autocorrelation function using the determined correction value; determining the highest peak point of the mixed autocorrelation function to be an open-loop pitch; dividing the detected open-loop pitch by an integer multiple of a specific value to acquire an autocorrelation function value, comparing the acquired autocorrelation function value with another autocorrelation function value at the pitch, and determining a point (or position) having the highest value to be an open-loop pitch.

The pitch analyzer using the aforementioned steps includes a time autocorrelation function calculator for calculating a time autocorrelation function upon receipt of the bandwidth-expanded residual signal; a spectral autocorrelation function calculator for calculating a spectral autocorrelation function upon receipt of the bandwidth-expanded residual signal; a correction value calculator for comparing a peak-to-valley difference value of the spectral autocorrelation function with a predetermined value to determine a correction value; a mixer for mixing the time autocorrelation function with the spectral autocorrelation function using the determined correction value; an open-loop pitch detector for determining the highest peak point of the mixed autocorrelation function to be an open-loop pitch; and a double-pitch detector for dividing the detected open-loop pitch by an integer multiple of a specific value to acquire an autocorrelation function value, comparing the acquired autocorrelation function value with another autocorrelation function value at the pitch, and determining a point (or position) having the highest value to be an open-loop pitch.

The aforementioned second method performs steps 422-434 shown in FIG. 4. Specifically, the second method calculates time and spectral autocorrelation functions upon receipt of the bandwidth-expanded residual signal, mixes the time autocorrelation function with the spectral autocorrelation function, and detects an open-loop pitch using the mixed autocorrelation function. In this case, if the open-loop pitch value is higher than a predetermined value, the second method performs a double-pitch analysis operation, and at the same time detects an open-loop pitch. Otherwise, if the open-loop pitch value is less than a predetermined value, the second method calculates the open-loop pitch using a low-pass-filtered voice signal.

In this case, a method for detecting the open-loop pitch using the pitch analyzer includes the steps of: receiving the bandwidth-expanded residual signal, and calculating a time autocorrelation function and a spectral autocorrelation function; comparing a peak-to-valley difference value of the spectral autocorrelation function with a predetermined value to determine a correction value; mixing the time autocorrelation function with the spectral autocorrelation function using the determined correction value; determining a point or position having the highest peak from among the mixed autocorrelation function to be a first open-loop pitch; comparing the first open-loop pitch with a predetermined first reference value; comparing an autocorrelation function value acquired when the detected first open-loop pitch is divided by an integer multiple of a specific value with another autocorrelation function value at a pitch if it is determined that the first open-loop pitch is higher than the first reference value, and determining a point or position having the highest value to be an open-loop pitch; receiving the low-pass-filtered voice signal if the first open-loop pitch is less than the first reference value, and generating a second time autocorrelation function; determining a point or position having the highest peak from among the second time autocorrelation function to be a second open-loop pitch; comparing the second open-loop pitch with a predetermined second reference value; comparing an autocorrelation function value acquired when the detected second open-loop pitch is divided by an integer multiple of a specific value with another autocorrelation function value at a pitch if it is determined that the second open-loop pitch is higher than the second reference value, and determining a point or position having the highest value to be an open-loop pitch; determining an average pitch to be the second open-loop pitch if the second open-loop pitch is less than the second reference value.

The pitch analyzer using the aforementioned operations includes a first time autocorrelation function calculator for calculating a time autocorrelation function upon receipt of the bandwidth-expanded residual signal; a spectral autocorrelation function calculator for calculating a spectral autocorrelation function upon receipt of the bandwidth-expanded residual signal; a, correction value calculator for comparing a peak-to-valley difference value of the spectral autocorrelation function with a predetermined value to determine a correction value; a mixer for mixing the time autocorrelation function with the spectral autocorrelation function using the determined correction value; a first open-loop pitch detector for determining the highest peak point of the mixed autocorrelation function to be an open-loop pitch; a first comparator for comparing the detected open-loop pitch value with a predetermined first reference value, generating a first comparison signal when the open-loop pitch value is higher than the first reference value, and generating a second comparison signal when the open-loop pitch value is the same or less than the first reference value; a first double pitch detector for comparing an autocorrelation function acquired when the detected open-loop pitch is divided by an integer multiple of a specific value at a time of generating the first comparison signal with another autocorrelation function at a pitch, and determining a point or position having the highest value to be an open-loop pitch; a second time autocorrelation function calculator for receiving the low-pass-filtered voice signal at a time of generating the second comparison signal, and generating a time autocorrelation function; a second open-loop pitch detector for determining a point or position having the highest peak from among the second time autocorrelation function to be a second open-loop pitch; a second comparator for comparing the detected second open-loop pitch value with a predetermined second reference value, generating a first comparison signal when the second open-loop pitch value is higher than the second reference value, and generating a second comparison signal when the second open-loop pitch value is the same or less than the second reference value; a second double pitch detector for comparing an autocorrelation function acquired when the second open-loop pitch is divided by an integer multiple of a specific value at a time of generating the first comparison signal from the second comparator with another autocorrelation function at a pitch, and determining a point or position having the highest value to be an open-loop pitch; and a determination unit for determining an average pitch to be the second open-loop pitch when the second comparator generates the second comparison signal.

The aforementioned open-loop pitch detection method will hereinafter be described with reference to FIG. 4.

The PAQ unit 40 calculates a time autocorrelation function (Rt) and a spectral autocorrelation function (Rs) upon receiving a bandwidth-expanded residual signal from the bandwidth expansion unit 210, and mixes the time autocorrelation function (Rt) with the spectral autocorrelation function (Rs), such that it can detect a pitch. Typically, an open loop pitch detection method can be established using a time autocorrelation function. The method for detecting the pitch using the time autocorrelation function has a disadvantage in that it frequently encounters double pitch detection errors, such that there is a need for the pitch detection method to improve detection stability using the spectral autocorrelation function. The aforementioned operations are performed using steps 412-420 of FIG. 4.

A detailed description of the aforementioned operations will hereinafter be described.

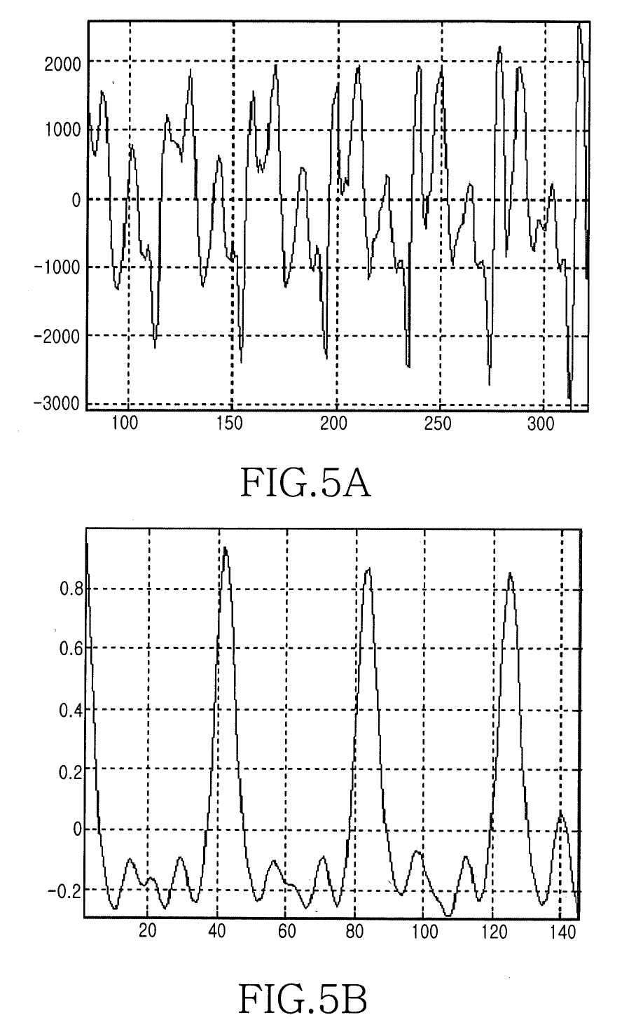

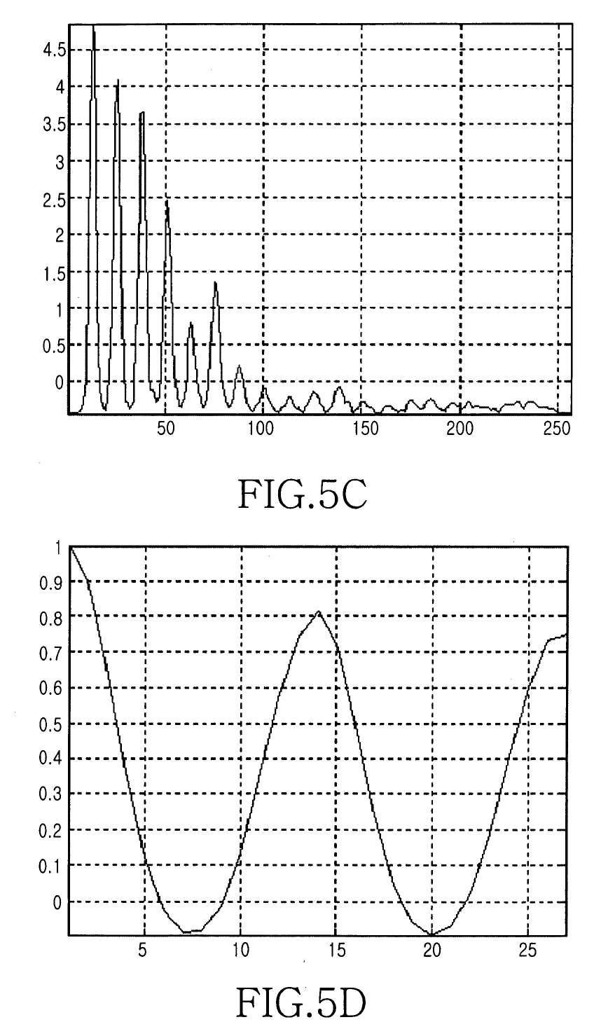

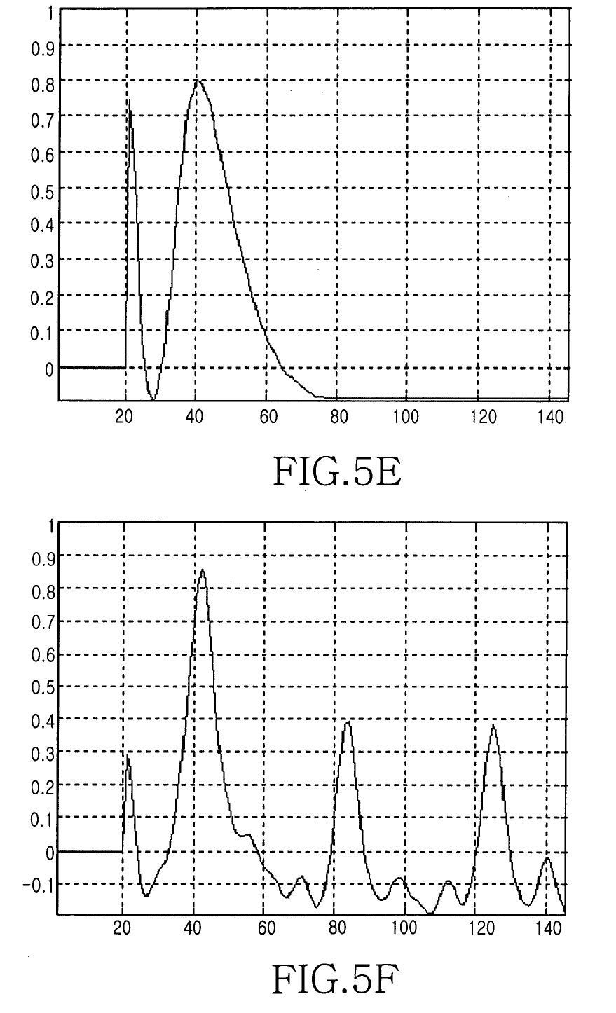

The pitch analyzer 230 can calculate a time autocorrelation function from among a time domain of the bandwidth-expanded input signal of FIG. 5A using the following Equation 2:

$${R}^{T} ( τ ) = \frac{{\sum }_{n = 0}^{N - τ - 1} \tilde{S} ( n ) \cdot \tilde{S} ( n + τ )}{\sqrt{{\sum }_{n = 0}^{N - τ - 1} {\tilde{S}}^{2} ( n ) {\sum }_{n = 0}^{N - τ - 1} {\tilde{S}}^{2} ( n + τ )}} \qquad Equation 2$$

With reference to Equation 2, \tilde{S}(n) is indicative of a zero-mean signal of S′(n), and N is indicative of the number of samples used for calculating an autocorrelation function to perform a pitch search operation. The pitch detection method based on a time autocorrelation function is frequently searched for using a double pitch, such that not only the time autocorrelation function method but also a spectral autocorrelation function method is adapted to compensate for the double pitch.

The pitch analyzer 230 calculates the spectral autocorrelation function in a frequency domain of the bandwidth-expanded input signal using the following Equation 3 at step 414:

$${R}^{S} ( τ ) = \frac{{\sum }_{k = 0}^{N - {k}_{τ} - 1} \tilde{S} ( k ) \cdot \tilde{S} ( k + {k}_{τ} )}{\sqrt{{\sum }_{k = 0}^{N - {k}_{τ} - 1} {\tilde{S}}^{2} ( k ) {\sum }_{k = 0}^{N - {k}_{τ} - 1} {\tilde{S}}^{2} ( k + {k}_{τ} )}} \qquad Equation 3$$

With reference to Equation 3, \tilde{S}(k) is indicative of a spectrum in which a spectrum is removed from the spectrum of \tilde{S}(n), and N is indicative of ½ of the number of DFT points and is also denoted by k_{τ}=2* N/τ. The pitch detection method based on the spectral autocorrelation function has a high probability of detecting a half pitch (i.e., τ/2 and τ/3) whereas it has a low probability of detecting the double pitch. Therefore, the time autocorrelation function pitch detection method and the spectral autocorrelation function pitch detection method must be used at the same time, resulting in increased pitch detection reliability. The pitch analyzer 230 mixes the time autocorrelation function of step 412 and the spectral autocorrelation function of step 414 using the following Equation 4, and searches for the pitch using the mixed result at step 418:
R(τ)=(1−β)·R^{T}(τ)+β·R^{S}(τ)

With reference to Equation 4, β is indicative of 0<β<1, and is typically determined to be 0.5. However, if a peak value of the spectral autocorrelation function is very low, the time autocorrelation function may be lowered. Therefore, if the peak value of the spectral autocorrelation function is the same or less than a specific value, it is preferable for the value of 1−β to be lowered.

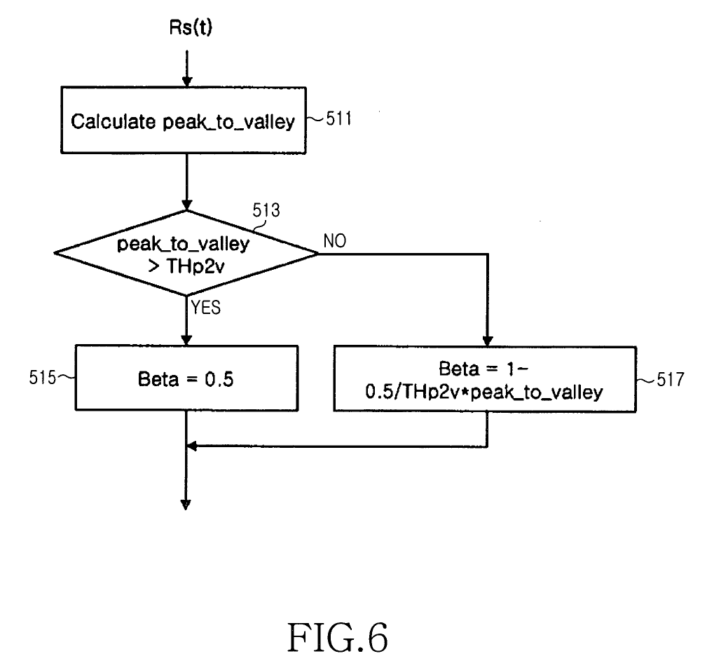

Therefore, the pitch analyzer 230 controls the value of B according to the peak value of the spectral autocorrelation function at step 416. FIG. 6 is a flow chart illustrating a procedure for controlling the specific value ‘β’ according to the peak value of the spectral autocorrelation function at step 416. If the peak value of the spectral autocorrelation function is very low, the time autocorrelation function may be lowered. Therefore, if the peak value of the spectral autocorrelation function is the same or less than a specific value, it is preferable for the value of β to be lowered. FIG. 6 shows a procedure for performing data conversion to reduce a reflection ratio of the spectral autocorrelation function.

Referring to FIG. 6, the pitch analyzer 230 calculates a peak-to-valley difference of the spectral autocorrelation function at step 511. In this case, the peak-to-valley difference is indicative of a difference between the highest peak value of Rs denoted by Equation 3 and a valley value closest to the highest peak value of Rs. After acquiring the peak-to-valley difference of the spectral autocorrelation function at step 511, the pitch analyzer 230 compares the peak-to-valley difference of the spectral autocorrelation function with a predetermined reference value ‘THp2v’ at step 513. In this case, if the peak-to-valley difference of the spectral autocorrelation function is higher than the reference value ‘THp2v’ at step 513, the pitch analyzer 230 determines that there is a stored harmonic component, and determines the value of 13 to be 0.5 at step 515, so that the spectral autocorrelation function has the same ratio as in the time autocorrelation function. Otherwise, if the peak-to-valley difference of the spectral autocorrelation function is less than the reference value ‘THp2v’ at step 513, the pitch analyzer 230 controls the value of β to be reduced in proportion to the peak-to-valley difference. In this case, the value of β may be denoted by ‘β=1−0.5/THp2v*peak_to_valley’ at step 517. The reference value ‘THp2v’ may be determined to be 0.05-0.3. Preferably, the reference value ‘THp2v’ is determined to be 0.15.

If the value of β is determined using the aforementioned method, the pitch analyzer 230 mixes the time autocorrelation function and the spectral autocorrelation using Equation 4 at step 418. The pitch analyzer 230 determines an open-loop pitch value P using the mixed signal of the time and spectral autocorrelation functions as shown in the following Equation 5 at step 420:

$$P = \frac{arg max \{ R ( t ) \}}{t} \qquad Equation 5$$

Specifically, the pitch analyzer 230 determines the position of t having the highest autocorrelation function from among a predetermined search period to be an open-loop pitch value P at step 420.

FIGS. 5A-5F are graphs illustrating individual signals of steps 412-420 in which the pitch analyzer 230 detects a pitch using time and spectral autocorrelation functions.

The bandwidth-expanded residual signal received in the pitch analyzer 230 is shown in FIG. 5A. The pitch analyzer 230 generates a time autocorrelation function of FIG. 5B using Equation 2 at step 412. The spectrum of the bandwidth-expanded residual signal of FIG. 5A is shown in FIG. 5C. The pitch analyzer 230 calculates a spectral autocorrelation function using the signal of FIG. 5C at step 414. In order to mix the time autocorrelation function and the spectral autocorrelation function, the spectral autocorrelation function of FIG. 5D must be converted into the time autocorrelation function. After converting the spectral autocorrelation function of FIG. 5D into the time autocorrelation function, the signal of FIG. 5E is generated. Thereafter, in the case of mixing the time autocorrelation function and the spectral autocorrelation function, a mixed autocorrelation function of FIG. 5F is generated. In this case, the highest peak value of the autocorrelation function can be acquired at a time point ‘t=42’, such that r(P) is determined to be 0.8 and the pitch ‘P’ is determined to be 42.

A variety of autocorrelation functions generated in time and frequency domains of a specific voice frame are shown in FIGS. 5A-5F. The pitch is detected in the range from a minimum pitch ‘20’ to a maximum pitch ‘146’, such that the autocorrelation function values of FIGS. 5E-5f are available only in the range of 20-146. It can be recognized that the time autocorrelation function is determined to be a high value at a real pitch and an integer multiple of the real pitch, as shown in FIG. 5B, resulting in increased probability of detecting a double pitch during the pitch detection time. The spectral autocorrelation function of FIG. 5E is considered to be a relatively-high value at even the half-pitch position as well as the real pitch position, resulting in increased probability of detecting the half pitch. As shown in FIG. 5F in which the time autocorrelation function and the spectral autocorrelation function are mixed with each other, it can be recognized that the real pitch shows a high value and the remaining pitches other than the real pitch show relatively low values.

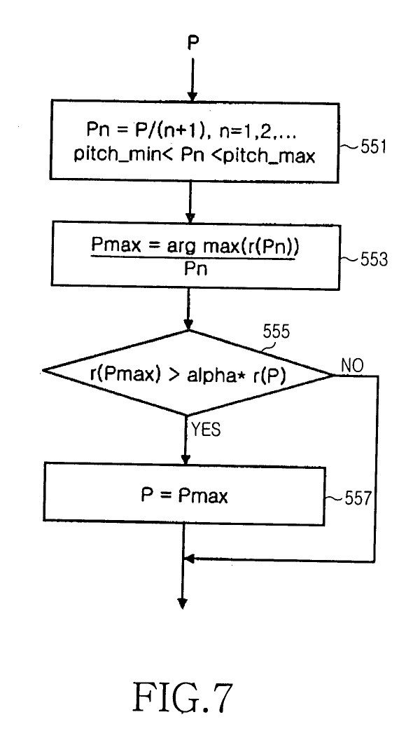

The pitch analyzer 230 compares the highest peak value r(P) calculated by the time and spectral autocorrelation functions with a predetermined reference value ‘TH1’ while performing steps 412-420. In this case, the reference value of TH1 is determined to be 0.5-0.8, and is preferably determined to be 0.6. Therefore, if the highest peak value of r(P) is higher than the reference value of TH1, it is determined that a corresponding pitch is a high periodic characteristic signal, the pitch analyzer 230 performs a double pitch search process for the corresponding pitch at step 438. In this case, the double pitch search process at step 438 is the same as in FIG. 7.

Referring to FIG. 7, the pitch analyzer 230 determines the position of Pn (where Pn=P(n+1), n=1,2,3, . . . ), and determines the determined position of Pn to be a specific value between a minimum pitch (pitch_min) and a maximum pitch (pitch_max). The specific value can also be denoted by ‘pitch_min<Pn<pitch_max’. In this case, the position of Pn is indicative of a position corresponding to either one of ½, ⅓, and ¼, and so on. The minimum pitch (pitch_min) is determined to be 20, and the maximum pitch (pitch_max) is determined to be 146, as shown in FIG. 5F. After determining the position of Pn, the pitch analyzer 230 inserts the position of Pn having the highest value of r(Pn) into all the values Pns, as shown in the following expression

$$P max = \frac{arg max \{ r ( Pn ) \}}{Pn}$$

Steps 551-553 are configured in the form of a loop statement repeated in the range from P1 to Pn during a double pitch search time, acquire a plurality of values Pn, select the highest value of r(Pn) from among the values of Pn, and determine the selected value of r(Pn) to be the value of Pmax.

The pitch analyzer 230 determines whether an autocorrelation function acquired at the pitch P at steps 551-553 is less than another autocorrelation function acquired at the pitch Pmax by a specific value a, as denoted by r(Pmax)>a*r(P). At step 555, if it is determined that the autocorrelation function acquired at the pitch Pmax is higher than the autocorrelation function acquired at the pitch P, the value of Pmax is re-determined to be the pitch P at step 557. Otherwise, if it is determined that the autocorrelation function acquired at the pitch Pmax is the same or less than the autocorrelation function acquired at the pitch P, the pitch analyzer 230 maintains a previous pitch P.

As stated above, if the double pitch search process of step 438 performs the procedures of FIG. 7, and at the same time determines whether an autocorrelation function r(Pn) at pitch lags (P1, P2, P3, . . . , and so on) corresponding to ½, ⅓, ¼, and so on of the searched pitch P is higher than the value of a *r(P), the pitch analyzer 230 determines the value of P to be a double pitch, and re-determines the value of Pn to be a pitch. In this case, if the value of P is higher than the value of 100, the value of 0.7 (i.e., about 0.6-0.8) is determined. If the value of P is the same or less than the value of 100, the value of 0.9 (i.e., about 0.8-0.95) is determined.

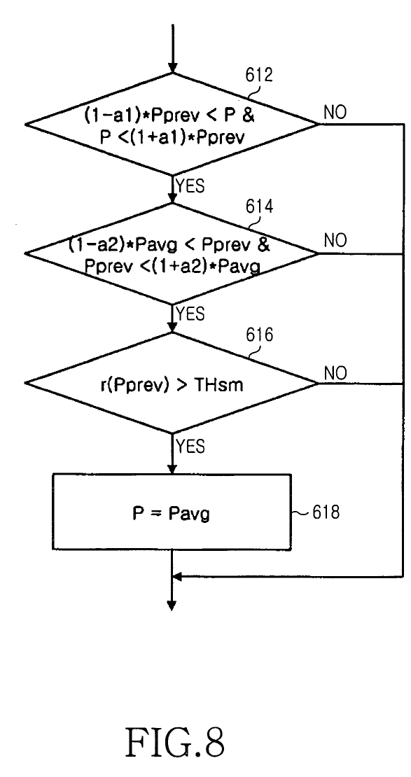

After searching for the double pitch at step 438, the pitch analyzer 230 outputs the double-pitch search result to the pitch smoothing unit 240, and the pitch smoothing unit 240 performs a smoothing operation to prevent the pitch from being abruptly changed. The pitch smoothing unit 240 smoothens the pitch using a specific value of Pavg. In this case, the average pitch of Pavg is adapted to smooth the pitch abruptly changed from a median-mean value to a calculated value in association with previous reliable pitch values. The pitch smoothing procedure of the pitch smoothing unit 240 at step 436 is shown in FIG. 8.

Referring to FIG. 8, in the case where the pitch smoothing unit 240 determines that an open-loop pitch of P is outside of a predetermined range (a1*100)% of a previous frame pitch ‘Pprev’ while performing steps 612-618, the pitch smoothing unit 240 determines that the pitch is abruptly changed to another pitch. At step 616, if the value of Pprev is in the range of (a2*100)% of the average pitch Pavg, and the maximum autocorrelation function of a previous frame is higher than the value of THsm (i.e., 0.5-0.7, preferably 0.6), the average pitch Pavg is determined to be an open-loop pitch at step 618. In this case, the value of al is in the range of 0.25-0.45, and it is preferable that the value of al is experimentally determined to be about 0.35. The value of a2 is in the range of 0.1-0.3, and it is preferable that the value of a2 is experimentally determined to be about 0.2.

However, if the highest peak value r(P) calculated by the time and spectral autocorrelation functions at steps 412-420 is less than the value of TH1 at step 422, the pitch analyzer 230 receives a low-pass-filtered signal of 1 kHz from the LPF 220 at step 424. The pitch analyzer 230 calculates the time autocorrelation function associated with the received 1 kHz low-pass-filtered signal using Equation 2 at step 426, and determines a point having the highest peak value to be an open-loop pitch P using Equation 5. Thereafter, the pitch analyzer 230 compares the pitch r(P) having the highest peak value of step 428 with a predetermined reference value TH2 at step 430, and goes to step 432 if the value of r(P) is higher than the value of TH2, such that the double pitch search process of FIG. 7 is performed. Otherwise, if the value of r(P) is less than the value of TH2, the pitch analyzer 230 determines the value of r(P) to be an average pitch ‘Pavg’. After performing steps 432-434, the pitch analyzer 230 outputs the resultant signal to the pitch smoothing unit 240. The pitch smoothing unit 240 smoothens the pitch P calculated by the procedures of FIG. 8 at step 436.

As stated above, if the highest peak value r(P) calculated by the time and spectral autocorrelation functions at steps 412-420 is less than the reference value of TH1, the pitch analyzer 230 receives the 1 kHz low-pass-filtered signal, instead of receiving the bandwidth-expanded residual signal generated from the bandwidth expansion unit 210, such that it can acquire a pitch. If the input signal is indicative of a signal having periodicity, little harmonic characteristics, and a strong low-frequency component, the periodicity is reduced when the pitch analyzer 230 calculates the residual signal, resulting in a reduced autocorrelation function. Therefore, in order to search for the pitch P of the aforementioned input signal, the pitch analyzer 230 calculates a time autocorrelation function associated with the 1 kHz low-pass-filtered signal, such that it can search for a desired pitch. In this case, provided that the calculated pitch is determined to be P, and the value of r(P) is higher than the value of TH2 (preferably, 0.4-0.7, experimentally 0.5), the pitch analyzer 230 determines the presence of periodicity, performs the double-pitch search process, and determines an open-loop pitch. In this case, the value for use in the double-pitch search process is determined to be 0.5 (about 0.4-0.6) when the value of P is higher than the value of 100. Otherwise, if the value of P is the same or less than the value of 100, the value for the double-pitch search process is determined to be 0.75 (about 0.6-0.8). If the value of P is less than the value of TH2, the pitch analyzer 230 determines the absence of periodicity, such that it adapts the average pitch Pavg as a current pitch. The method for calculating the average pitch is the same as in the MELP-based method.

As can be seen from the pitch detection process for use in the pitch analyzer 230, the pitch analyzer 230 searches for an open-loop pitch using the time and spectral autocorrelation functions. If the searched autocorrelation function is higher than the specific reference value of TH1, the pitch analyzer 230 performs the double-pitch search process so that it can determine an open-loop pitch. In this case, during the double-pitch search process, the pitch calculated by the autocorrelation is divided by an integer multiple of a specific value, and at the same time its nearby autocorrelation function is compared with an autocorrelation function at the pitch in such a way that the double-pitch search process can be established.

If the searched autocorrelation is less than the specific reference value TH12, the pitch analyzer 230 acquires an open-loop pitch using a low-pass-filtered signal having a predetermined frequency band. It is assumed that the predetermined frequency band is equal to 1 kHz in the present invention. Therefore, the pitch analyzer 230 calculates the time autocorrelation function using the 1 kHz low-pass-filtered signal, and searches for a pitch having the highest peak value. In more detail, the time and spectral autocorrelation functions are determined to be low values when receiving a sinusoidal signal having a strong low-frequency component, such that the pitch analyzer 230 performs the aforementioned pitch search process to extract only a low-frequency component from overall frequency components.

However, if the calculated autocorrelation functions are determined to be low values in the aforementioned two cases, the average pitch value is adapted as a current pitch value.

The pitch value calculated by the aforementioned pitch detection/smoothing processes is transmitted to the fine pitch search unit 250. The process for converting the spectral autocorrelation function into the time autocorrelation function is performed by interpolation of nearby values, such that the peak value of the spectral autocorrelation function may be slightly different from a real value. Also, the pitch detection process in the time domain may encounter unexpected errors as compared to the real pitch value, such that it performs a fine pitch search process in the vicinity of the pitch acquired from the open loop. The fine pitch detection algorithm changes a pitch value and at the same time performs a desired search process, such that it can minimize a difference between a synthetic signal spectrum associated with the pitch value and an original signal spectrum. The aforementioned fine pitch detection algorithm has been proposed by D. griffin and J. S. Lim, who have published a research paper entitled “MULTI-BAND EXCITATION VOCODER” in IEEE Trans. on ASSP, Vol.36, No. 8, pp. 1223-1235 on August 1988 which is incorporated by reference in its entirety.

The fine pitch search part 250 can use a typical algorithm shown in the aforementioned research paper for searching for a fractional pitch minimizing a spectrum error, such that it can search for a pitch finer than an integer pitch. However, the vocoder for use in the present invention does not require a fine pitch value higher than the integer value during the voice mixing process, such that it may select a pitch having the least error from among ±2 samples positioned in the vicinity of the pitch calculated by the open-loop pitch detection process when applying the fine pitch algorithm, and may also determine the selected pitch to be the final pitch.

The pitch acquired from the open-loop pitch process, the pitch smoothing process, and the fine pitch search process is transmitted to the pitch quantizer 270, and is also transmitted to the average pitch update unit 260. The pitch update unit 260 updates average pitches of the pitch analyzer 230 and the pitch smoothing unit 240 upon receipt of the final detection pitch. Operations of the average pitch update unit 260 are equal to those of the MELP-based method.

The finely-searched pitch generated from the fine pitch search unit 250 is quantized by the pitch quantizer 270. In this case, the range from the minimum pitch (pitch_min, preferably ‘20’ in an embodiment of the present invention) to the maximum pitch (pitch_max, preferably ‘146’ in an embodiment of the present invention) is divided into predetermined levels (e.g., 127 levels), and the divided result is quantized. Therefore, the pitch quantizer 270 divides the pitch of 20-146 into 127 levels, such that it can be linearly quantized into values of 1-127. In this case, the value of 0 is assigned to a state of unvoiced sound, such that the pitch value may not be transmitted to a target if needed. Therefore, the pitch quantizer 270 quantizes the pitch into 7-bits data, and the quantized 7-bits data is transmitted to the multiplexer 70 as a pitch parameter.

As apparent from the above description, the pitch detection method in accordance with embodiments of the present invention expands a bandwidth of an input signal when inverse-filtering the input signal, such that it can prevent a corresponding harmonic component from being distorted when a formant frequency exists in a pitch harmonic component. The pitch detection method calculates an open-loop pitch using time and spectral autocorrelation functions when searching for the open-loop pitch, resulting in increased reliability of the searched pitch. If the searched pitch is less than a predetermined reference value during the open-loop pitch search time, the pitch detection method calculates an open-loop pitch using an autocorrelation function of a low-pass-filtered signal of a predetermined frequency, resulting in increased reliability of the searched pitch. Also, the pitch detection method smoothens the searched pitch, such that it can prevent an abrupt pitch variation from being generated during the open-loop pitch search process. Furthermore, the pitch detection method adapts a fine pitch search process to the searched pitch, such that it can correct unexpected errors generated during the pitch detection process.

Although certain embodiments of the present invention have been disclosed for illustrative purposes, those skilled in the art will appreciate that various modifications, additions and substitutions are possible, without departing from the scope and spirit of the invention as disclosed in the accompanying claims.

1. A pitch detection apparatus for use in a vocoder, comprising:
a bandwidth expansion unit for performing an inverse-filtering process and a bandwidth expansion process on an input voice signal, and generating a bandwidth-expanded residual signal;
a pitch analyzer for calculating a time autocorrelation function and a spectral autocorrelation function of the bandwidth-expanded residual signal, mixing the time autocorrelation function and the spectral autocorrelation function, comparing an autocorrelation function calculated by dividing a pitch acquired from the mixed autocorrelation function by an integer multiple with another autocorrelation function acquired at a predetermined pitch, and determining a point or position having the highest value to be an open-loop pitch;
a pitch smoothing unit for smoothing the open-loop pitch using an average pitch value when the detected open-loop pitch is outside of a predetermined range of a previous frame; and
a pitch quantizer for quantizing the smoothened open-loop pitch into predetermined levels, and generating the quantized result.

2. The apparatus according to claim 1, further comprising:
a fine pitch search unit connected between the pitch smoothing unit and the pitch quantizer, for selecting a pitch having the least error from among ±2 samples positioned in the vicinity of a pitch value calculated by the open-loop pitch, and determining the selected pitch to be a final pitch.

3. The apparatus according to claim 1, wherein the bandwidth expansion unit performs the inverse-filtering process and the bandwidth expansion process on the input signal using the following equation:
$${S}^{′} ( z ) = \frac{A ( z )}{A ( z / γ )} \cdot S ( z )$$
where γ is indicative of a weight factor.

4. The apparatus according to claim 3, wherein the pitch analyzer includes:
a time autocorrelation function calculator for calculating a time autocorrelation function upon receipt of the bandwidth-expanded residual signal;
a spectral autocorrelation function calculator for calculating a spectral autocorrelation function upon receipt of the bandwidth-expanded residual signal;
a correction value calculator for comparing a peak-to-valley difference value of the spectral autocorrelation function with a predetermined value to determine a correction value;
a mixer for mixing the time autocorrelation function with the spectral autocorrelation function using the determined correction value;
an open-loop pitch detector for determining the highest peak point of the mixed autocorrelation function to be an open-loop pitch; and
a double-pitch detector for dividing the detected open-loop pitch by an integer multiple of a specific value to acquire an autocorrelation function value, comparing the acquired autocorrelation function value with another autocorrelation function value acquired at a pitch, and determining a point or position having the highest value to be an open-loop pitch.

5. The apparatus according to claim 4, wherein the pitch analyzer:
controls the time autocorrelation function calculator to calculate the time autocorrelation function using the following equation:
$${R}^{T} ( τ ) = \frac{{\sum }_{n = 0}^{N - τ - 1} \tilde{S} ( n ) \cdot \tilde{S} ( n + τ )}{\sqrt{{\sum }_{n = 0}^{N - τ - 1} {\tilde{S}}^{2} ( n ) {\sum }_{n = 0}^{N - τ - 1} {\tilde{S}}^{2} ( n + τ )}}$$
where \tilde{S}(n) is indicative of a zero-mean signal of S′(n), and N is indicative of the number of samples needed to perform a pitch search operation,
controls the spectral autocorrelation function calculator to calculate the spectral autocorrelation function in association with the bandwidth-expanded residual signal using the following equation:
$${R}^{S} ( τ ) = \frac{{\sum }_{k = 0}^{N - {k}_{τ} - 1} \tilde{S} ( k ) \cdot \tilde{S} ( k + {k}_{τ} )}{\sqrt{{\sum }_{k = 0}^{N - {k}_{τ} - 1} {\tilde{S}}^{2} ( k ) {\sum }_{k = 0}^{N - {k}_{τ} - 1} {\tilde{S}}^{2} ( k + {k}_{τ} )}}$$
where \tilde{S}(k) is indicative of a spectrum in which a spectrum is removed from a spectrum of \tilde{S}(n), and N is indicative of ½ of the number of DFT points and is also denoted by k_{τ}=2*N/τ,
controls the mixer to mix the time autocorrelation function and the spectral autocorrelation function on the basis of the correction value using the following equation:
R(τ)=(1−β)·R^{T}(τ)+β·R^{S}(τ), where β=0<β<1, and
controls the open-loop pitch detector to determine a point having the highest peak value from among the mixed autocorrelation function to be an open-loop pitch using an equation denoted by
$$P = \frac{arg max \{ R ( t ) \}}{t} .$$

6. The apparatus according to claim 1, further comprising:
an average pitch update unit for updating a pitch received in the pitch quantizer with an average pitch, and transmitting the updated result to the pitch analyzer and the pitch smoothing unit.

7. The apparatus according to claim 2, further comprising:
an average pitch update unit for updating a pitch received in the pitch quantizer with an average pitch, and transmitting the updated result to the pitch analyzer and the pitch smoothing unit.

8. A pitch detection apparatus for use in a vocoder, comprising:
a bandwidth expansion unit for performing an inverse-filtering process and a bandwidth expansion process on an input voice signal, and generating a bandwidth-expanded residual signal;
a Low Pass Filter (LPF) for low-pass-filtering the input voice signal using a predetermined frequency band;
a pitch analyzer for calculating a time autocorrelation function and a spectral autocorrelation function of the bandwidth-expanded residual signal, mixing the time autocorrelation function and the spectral autocorrelation function, performing a double-pitch search process on the pitch calculated by the mixed autocorrelation function, determining a point having the highest value to be an open-loop pitch, calculating a time autocorrelation function of the low-pass-filtered voice signal when an autocorrelation function acquired from the detected open-loop pitch is less than a predetermined reference value, and performing the double-pitch search process to search for an open-loop pitch;
a pitch smoothing unit for smoothing the open-loop pitch using an average pitch value when the detected open-loop pitch is outside of a predetermined range of a previous frame; and
a pitch quantizer for quantizing the smoothened open-loop pitch into predetermined levels, and generating the quantized result.

9. The apparatus according to claim 8, further comprising:
a fine pitch search unit connected between the pitch smoothing unit and the pitch quantizer, for selecting a pitch having the least error from among ±2 samples positioned in the vicinity of a pitch value calculated by the open-loop pitch, and determining the selected pitch to be a final pitch.

10. The apparatus according to claim 8, wherein the pitch analyzer includes:
a first time autocorrelation function calculator for calculating a time autocorrelation function upon receipt of the bandwidth-expanded residual signal;
a spectral autocorrelation function calculator for calculating a spectral autocorrelation function upon receipt of the bandwidth-expanded residual signal;
a correction value calculator for comparing a peak-to-valley difference value of the spectral autocorrelation function with a predetermined value to determine a correction value;
a mixer for mixing the time autocorrelation function with the spectral autocorrelation function using the determined correction value;
a first open-loop pitch detector for determining the highest peak point of the mixed autocorrelation function to be an open-loop pitch;
a first comparator for comparing the detected open-loop pitch value with a predetermined first reference value, generating a first comparison signal when the open-loop pitch value is higher than the first reference value, and generating a second comparison signal when the open-loop pitch value is the same or less than the first reference value;
a first double pitch detector for comparing an autocorrelation function acquired when the detected open-loop pitch is divided by an integer multiple of a specific value at a time of generating the first comparison signal with another autocorrelation function at a pitch, and determining a point or position having the highest value to be an open-loop pitch;
a second time autocorrelation function calculator for receiving the low-pass-filtered voice signal at a time of generating the second comparison signal, and generating a second time autocorrelation function;
a second open-loop pitch detector for determining a point or position having the highest peak from among the second time autocorrelation function to be a second open-loop pitch;
a second comparator for comparing the detected second open-loop pitch value with a predetermined second reference value, generating a first comparison signal when the second open-loop pitch value is higher than the second reference value, and generating a second comparison signal when the second open-loop pitch value is the same or less than the second reference value;
a second double pitch detector for comparing an autocorrelation function acquired when the second open-loop pitch is divided by an integer multiple of a specific value at a time of generating the first comparison signal from the second comparator with another autocorrelation function at a pitch, and determining a point or position having the highest value to be an open-loop pitch; and
a unit for determining an average pitch to be the second open-loop pitch when the second comparator generates the second comparison signal.

11. The apparatus according to claim 8, further comprising:
an average pitch update unit for updating a pitch received in the pitch quantizer with an average pitch, and transmitting the updated result to the pitch analyzer and the pitch smoothing unit.

12. The apparatus according to claim 9, further comprising:
an average pitch update unit for updating a pitch received in the pitch quantizer with an average pitch, and transmitting the updated result to the pitch analyzer and the pitch smoothing unit.

13. A method for detecting a pitch from among an input voice signal in a vocoder, comprising:
performing an inverse-filtering process and a bandwidth expansion process on an input voice signal, and generating a bandwidth-expanded residual signal;
calculating a time autocorrelation function and a spectral autocorrelation function of the bandwidth-expanded residual signal, mixing the time autocorrelation function and the spectral autocorrelation function, comparing an autocorrelation function calculated by dividing a pitch acquired from the mixed autocorrelation function by an integer multiple with another autocorrelation function acquired at a predetermined pitch, and determining a point or position having the highest value to be an open-loop pitch;
smoothing the open-loop pitch using an average pitch value when the detected open-loop pitch is outside of a predetermined range of a previous frame; and
quantizing the smoothened open-loop pitch into predetermined levels, and generating the quantized result.

14. The method according to claim 13, further comprising:
selecting a pitch having the least error from among +2 samples positioned in the vicinity of a pitch value from the calculating step, and determining the selected pitch to be a final pitch.

15. The method according to claim 13, wherein the calculating step for detecting the open-loop pitch further comprises:
calculating a time autocorrelation function and a spectral autocorrelation function upon receiving the bandwidth-expanded residual signal;
comparing a peak-to-valley difference value of the spectral autocorrelation function with a predetermined value to determine a correction value;
mixing the time autocorrelation function with the spectral autocorrelation function using the determined correction value;
determining the highest peak point of the mixed autocorrelation function to be an open-loop pitch; and
dividing the detected open-loop pitch by an integer multiple of a specific value to acquire an autocorrelation function value, comparing the acquired autocorrelation function value with another autocorrelation function value acquired at a pitch, and determining a point or position having the highest value to be an open-loop pitch.

16. A method for detecting a pitch of a voice signal in a vocoder, comprising:
performing an inverse-filtering process and a bandwidth expansion process on an input voice signal, and generating a bandwidth-expanded residual signal;
low-pass-filtering the input voice signal using a predetermined frequency band;
calculating a time autocorrelation function and a spectral autocorrelation function of the bandwidth-expanded residual signal, mixing the time autocorrelation function and the spectral autocorrelation function, performing a double-pitch search process on the pitch calculated by the mixed autocorrelation function, determining a point having the highest value to be an open-loop pitch, calculating a time autocorrelation function of the low-pass-filtered voice signal when an autocorrelation function acquired from the detected open-loop pitch is less than a predetermined reference value, and performing the double-pitch search process to search for an open-loop pitch;
smoothing the open-loop pitch using an average pitch value when the detected open-loop pitch is outside of a predetermined range of a previous frame; and
quantizing the smoothened open-loop pitch into predetermined levels, and generating the quantized result.

17. The method according to claim 16, further comprising:
selecting a pitch having the least error from among ±2 samples positioned in the vicinity of a pitch value calculated by the open-loop pitch, and determining the selected pitch to be a final pitch.

18. The method according to claim 14, wherein the calculating step for detecting the open-loop pitch further comprises:
calculating a time autocorrelation function and a spectral autocorrelation function upon receiving the bandwidth-expanded residual signal;
comparing a peak-to-valley difference value of the spectral autocorrelation function with a predetermined value to determine a correction value;
mixing the time autocorrelation function with the spectral autocorrelation function using the determined correction value;
determining the highest peak point of the mixed autocorrelation function to be a first open-loop pitch;
comparing the detected first open-loop pitch value with a predetermined first reference value;
comparing an autocorrelation function acquired when the detected first open-loop pitch is divided by an integer multiple of a specific value with another autocorrelation function at a pitch, and determining a point or position having the highest value to be an open-loop pitch if the first open-loop pitch value is higher than the predetermined first reference value;
receiving the low-pass-filtered voice signal, and generating a second time autocorrelation function if the first open-loop pitch value is less than the first reference value;
determining a point or position having the highest peak from among the second time autocorrelation function to be a second open-loop pitch;
comparing the detected second open-loop pitch value with a predetermined second reference value;
comparing an autocorrelation function acquired when the detected second open-loop pitch is divided by an integer multiple of a specific value with another autocorrelation function at a pitch, and determining a point or position having the highest value to be an open-loop pitch if the second open-loop pitch value is higher than the second reference value; and
determining an average pitch to be a second open-loop pitch if the second open-loop pitch value is less than the second reference value.
